(19) United States
(12) Patent Application Publication
(10) Pub. No.: US 2003/0096144 A1
(43) Pub. Date: May 22, 2003

(54) System to remove heat and water from a fuel cell powered device

(76) Inventor: Robert A. Dunstan, Forest Grove, OR (US)

Correspondence Address: Pillsbury Winthrop LLP, Intellectual Property Group, Suite 2800, 725 South Figueroa Street, Los Angeles, CA, 90017-5406, US

(21) Appl. No.: 09/990,398

(22) Filed: Nov. 20, 2001

(51) Int. Cl. H01M 8/10

(52) U.S. Cl. 429/17; 429/19; 429/39

(57) ABSTRACT

A fuel cell powered system includes a fuel cell. A water-holding device is included to receive a water byproduct from the fuel cell. A heat-generating device is in close proximity to the water-holding device to facilitate evaporation of the water byproduct.

### BACKGROUND OF THE INVENTION

1. Field of the Invention

The present invention generally relates to a fuel cell byproduct removal system. More particularly, the present invention relates to a fuel cell byproduct removal system that removes water byproduct from a fuel cell and employs a heat-generating device to facilitate evaporation of the water byproduct.

2. Discussion of the Related Art

Fuel cell technology offers a mechanism of producing power more efficiently and with less pollution than many conventional means. A fuel cell may be quickly recharged by adding fuel. Whereas, rechargeable batteries, which are often employed in modern electronic devices, for example, must be connected to a charger for an extended period of time to recharge.

A fuel cell comprises four basic parts: an anode, a catalyst, a cathode, and an electrolyte. The anode is the negative terminal of the fuel cell and disperses hydrogen molecules over the surface of the catalyst. Hydrogen gas is pressurized, which forces hydrogen through the catalyst.

The catalyst is typically made of carbon paper or cloth and is coated, for example, with platinum, which promotes the reaction of hydrogen and oxygen. When a hydrogen molecule contacts the catalyst, it splits into two positive hydrogen ions and two electrons. The anode supplies the electrons to power an external device, after which the electrons return to the cathode.

The cathode is the positive terminal of the fuel cell and disperses oxygen molecules over the surface of the catalyst. Because the oxygen is pressurized, it is forced through the catalyst, where each oxygen molecule forms two negatively-charged oxygen atoms.

The electrolyte is typically a thin plastic sheet that resembles ordinary kitchen wrap. Highly dispersed metal alloy particles coat both sides of the plastic sheet and are active catalysts. The electrolyte conducts positive ions, while blocking electrons. Thus, the two positive hydrogen ions travel through the electrolyte to combine with one of the negatively-charged oxygen atoms and the two electrons that returned from the external device, thereby forming a water molecule.

Because fuel cells convert hydrogen and oxygen into electricity and heat, water is the only byproduct if pure hydrogen is used as a fuel. However, the production of water is often an undesired byproduct within a system, particularly one that contains electronic devices.

Thus, a fuel cell byproduct removal system to remove the water byproduct from the fuel cell is required.

### BRIEF DESCRIPTION OF THE DRAWINGS

FIG. 1a, FIG. 1b, and FIG. 1c each illustrate a fuel cell byproduct removal system according to embodiments of the present invention;

FIG. 2 illustrates a fuel cell byproduct removal system according to another embodiment of the present invention;

FIG. 3 illustrates a flow chart for a method of removing water from a fuel cell according to an embodiment of the present invention;

FIG. 4 illustrates a flow chart for a method of removing water from a fuel cell according to another embodiment of the present invention;

FIG. 5 illustrates a portable electronic device powered by a fuel cell according to an embodiment of the present invention;

FIG. 6 illustrates a fuel cell powered system according to an embodiment of the present invention;

FIG. 7 illustrates a flow chart for a method of removing heat from a fuel cell powered system according to an embodiment of the present invention; and

FIG. 8 illustrates a flow chart for a method of removing heat from a fuel cell powered system according to another embodiment of the present invention.

### DETAILED DESCRIPTION

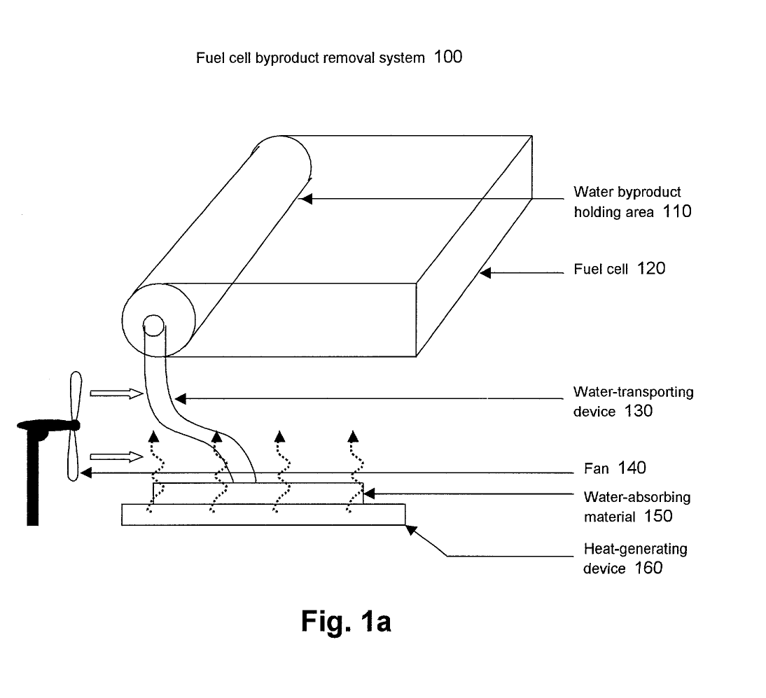

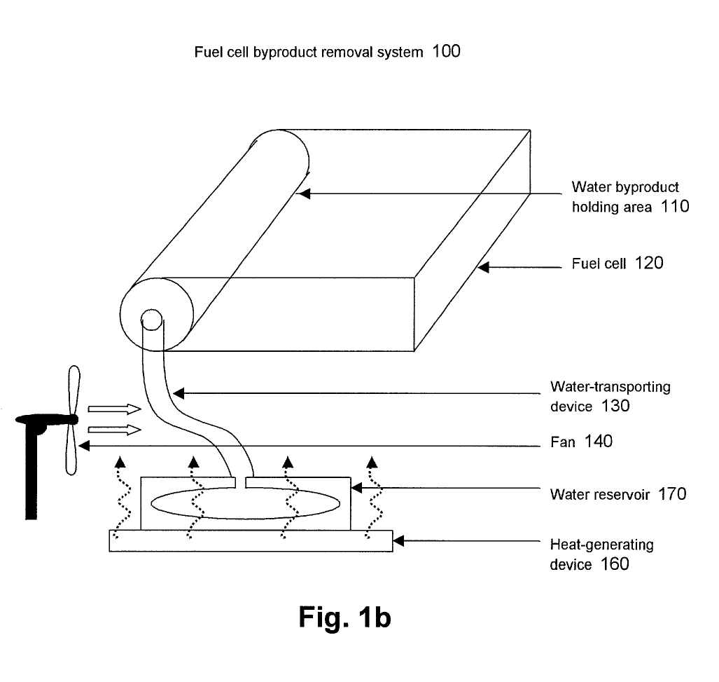

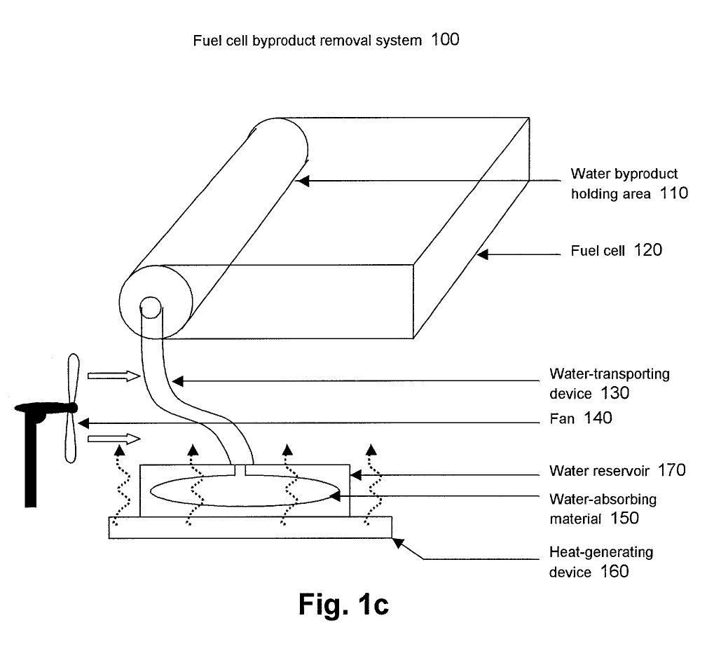

FIG. 1a, FIG. 1b, and FIG. 1c each illustrate a fuel cell byproduct removal system according to embodiments of the present invention. The fuel cell byproduct removal system 100 includes a fuel cell 120, a water-transporting device 130, and a heat-generating device 160. The water-transporting device 130 is coupled to the fuel cell 120 to remove a water byproduct. A water byproduct holding area 110 may be provided to receive the water byproduct before the water byproduct is removed by the water-transporting device 130. The heat-generating device 160 preferably facilitates evaporation of the water byproduct. A fan may be provided to facilitate cooling and evaporation of the water byproduct by blowing air across a water-absorbing material 150 and/or a water reservoir 170. The fan may facilitate removal of the water-byproduct by powering a pump and/or evaporating the water byproduct in a wick, causing the water byproduct to be drawn along the wick.

According to the embodiment as illustrated in FIG. 1a, the water byproduct is delivered to a water-absorbing material 150. According to the embodiment as illustrated in FIG. 1b, the water byproduct is delivered to a water reservoir 170. According to the embodiment as illustrated in FIG. 1c, the water byproduct is delivered to a water-absorbing material 150 and a water reservoir 170. The water-absorbing material 150 may be, for example, a sponge or a sponge-like material, but any other suitable material may be utilized.

In another embodiment of the invention, the water-transporting device 130 delivers the water byproduct to at least one of a water-absorbing material 150 and a water reservoir 170. The water-absorbing material 150 and/or the water reservoir 170 may be combined with, or form part of, a heat sink; however, any other suitable configuration may be utilized.

The water-transporting device 130 may include a wick according to another embodiment of the invention. In another embodiment, the water-transporting device 130 includes a tube. However, the water-transporting device 130 may be any suitable device and/or material that may be used to transport the water byproduct to a water-absorbing material 150 and/or a water reservoir 170.

According to one embodiment of the present invention, the heat-generating device 160 is a semiconductor device, such as a microprocessor, or a plurality of semiconductor devices, such as a memory module.

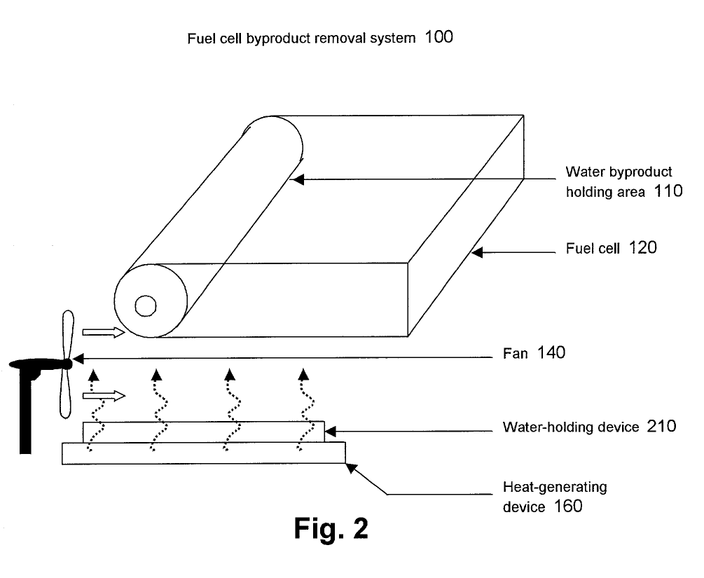

FIG. 2 illustrates a fuel cell byproduct removal system according to another embodiment of the present invention. The fuel cell byproduct removal system 100 includes a fuel cell 120, a water-holding device 210, and a heat-generating device 160. The heat-generating device 160 is in close proximity to the water-holding device 210 to facilitate evaporation of the water byproduct. Close proximity is defined to include direct contact between the heat-generating device 160 and the water-holding device 210. A water byproduct holding area 110 may be provided to receive the water byproduct before the water byproduct is received by the water-holding device 210. The water byproduct may drip from the water byproduct holding area 110 and/or the fuel cell onto the water-holding device 210. A fan 140 may be provided to facilitate cooling and evaporation of the water byproduct by blowing air across the water-holding device 210. A fan may also be provided in FIGS. 1a, 1b, and 1c.

According to an embodiment of the invention, the water-holding device 210 includes a water-absorbing material to absorb the water byproduct. In another embodiment, the water-holding device 210 includes a water reservoir. Alternatively, the water-holding device 210 may include a water-absorbing material to absorb a water byproduct and a water reservoir. In yet another embodiment, the water-holding device 210 is a sponge or a sponge-like material, or any other suitable material.

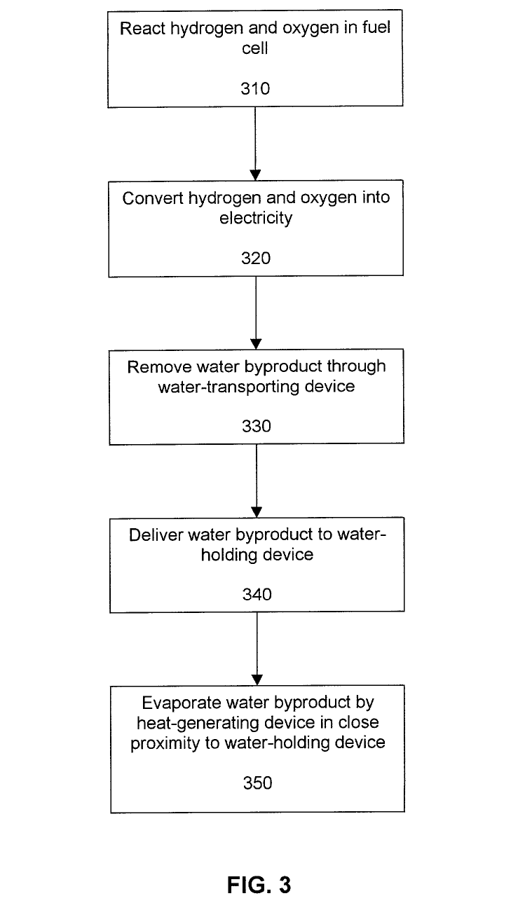

FIG. 3 illustrates a flow chart for a method of removing water from a fuel cell according to an embodiment of the present invention. Within the method, hydrogen is reacted 310 with oxygen in the fuel cell. The hydrogen and oxygen are converted 320 into electricity. The water byproduct is removed 330 through a water-transporting device 130. The water byproduct is delivered 340 to a water-holding device 210. The water byproduct is evaporated 350 by a heat-generating device 160 in close proximity to the water-holding device 210.

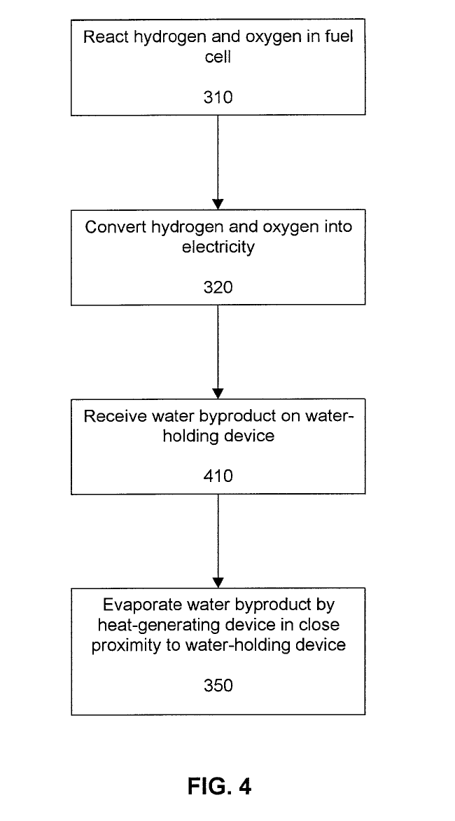

FIG. 4 illustrates a flow chart for a method of removing water from a fuel cell according to another embodiment of the present invention. Within the method, hydrogen is reacted 310 with oxygen in the fuel cell. The hydrogen and oxygen are converted 320 into electricity. The water byproduct is received 410 by a water-holding device 210. The water byproduct is evaporated 350 by a heat-generating device 160 in close proximity to the water-holding device 210.

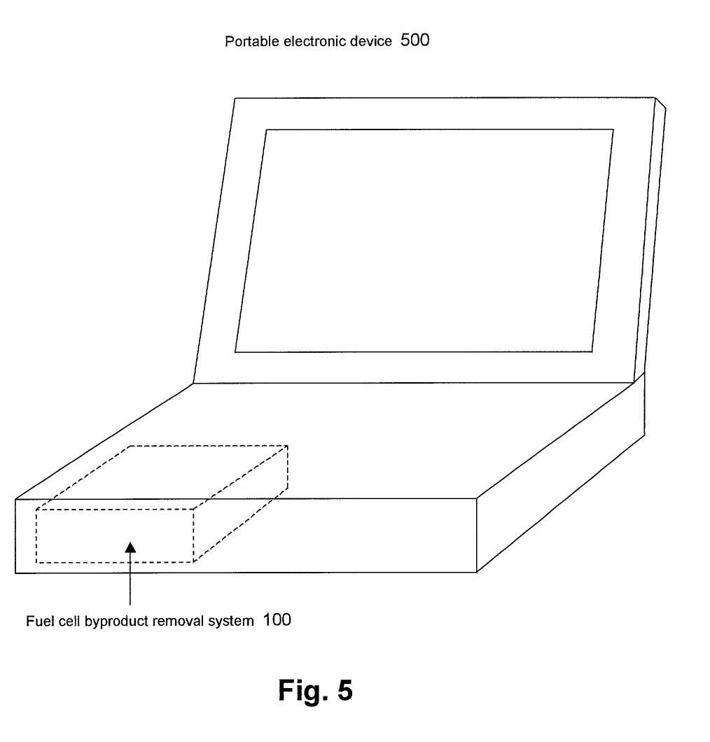

FIG. 5 illustrates a portable electronic device powered by a fuel cell according to an embodiment of the present invention. The portable electronic device 500 powered by a fuel cell includes a fuel cell byproduct removal system 100, as illustrated, for example, in FIGS. 1a, 1b, 1c, and 2. In another embodiment of the invention, the portable electronic device 500 is a notebook computer.

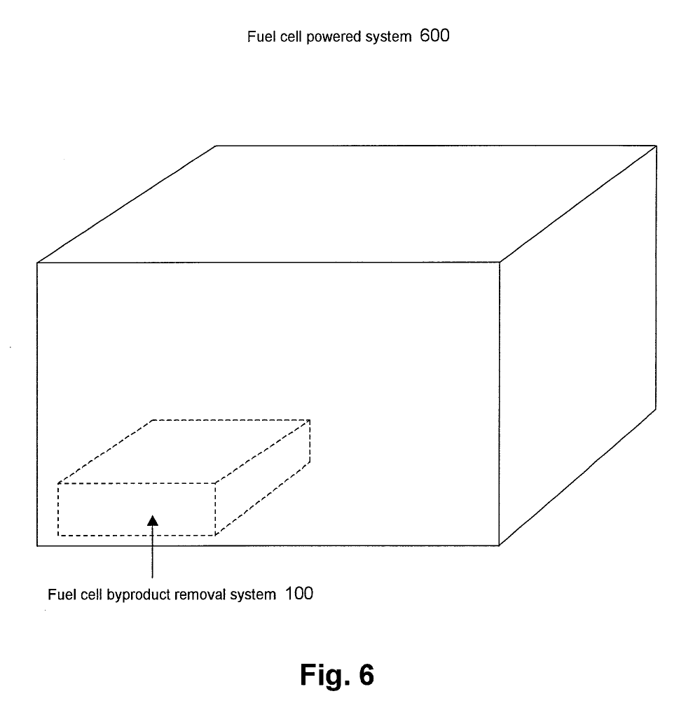

FIG. 6 illustrates a fuel cell powered system according to an embodiment of the present invention. The fuel cell powered system 600 includes a fuel cell byproduct removal system 100, as illustrated, for example, in FIGS. 1a, 1b, 1c, and 2.

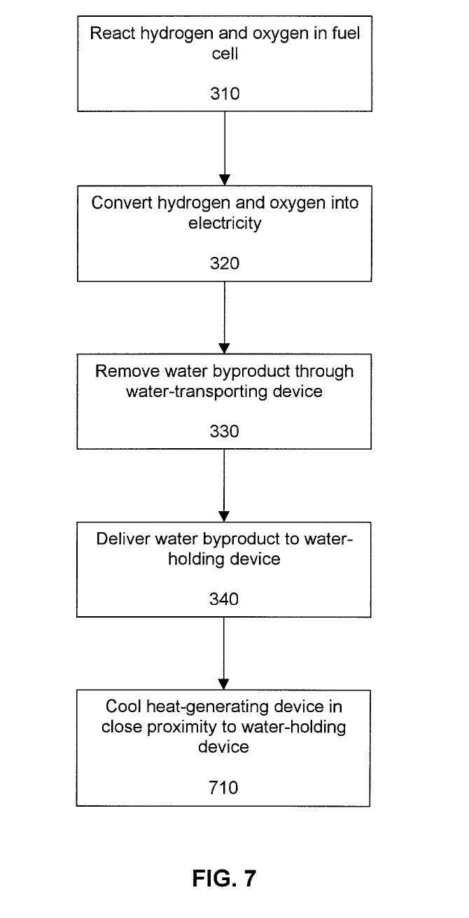

FIG. 7 illustrates a flow chart for a method of removing heat from a fuel cell powered system according to an embodiment of the present invention. Within the method, hydrogen is reacted 310 with oxygen in the fuel cell. The hydrogen and oxygen are converted 320 into electricity. The water byproduct is removed 330 through a water-transporting device 130. The water byproduct is delivered 340 to a water-holding device 210. A heat-generating device 160 in close proximity to the water-holding device 210 is cooled 710. In another embodiment of the invention, the fuel cell powered system 600 (see FIG. 6) is a portable electronic device 500 (see FIG. 5). According to yet another embodiment, the fuel cell powered system 600 is a notebook computer.

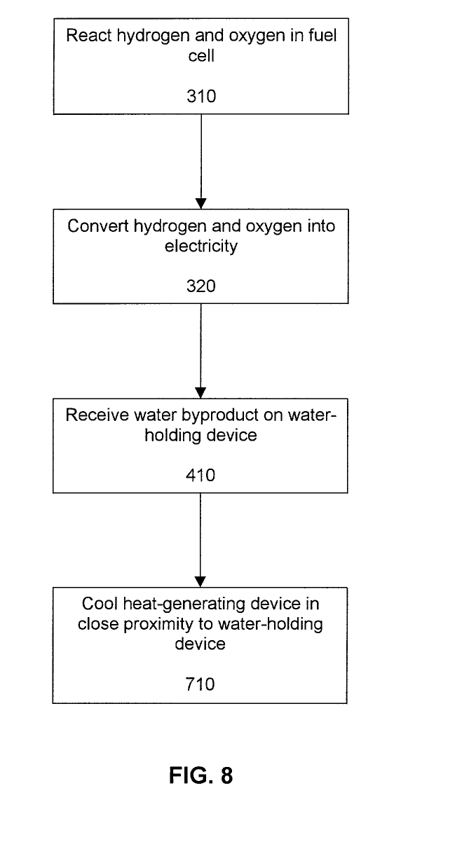

FIG. 8 illustrates a flow chart for a method of removing heat from a fuel cell powered system according to another embodiment of the present invention. Within the method, hydrogen is reacted 310 with oxygen in the fuel cell. The hydrogen and oxygen are converted 320 into electricity. The water byproduct is received 410 by a water-holding device 210. A heat-generating device 160 in close proximity to the water-holding device 210 is cooled 710.

In summary, the fuel cell byproduct removal system 100 according to the present invention removes heat and unwanted byproduct, namely water, from a fuel cell powered system. Water is expelled from the system as a gas along with air that is used to cool the heat-generating device 160. The fuel cell byproduct removal system 100 reduces the amount of water that may diffuse through the fuel cell 120, thereby reducing the amount of water that accumulates on the outside surface of the fuel cell 120. Furthermore, the fuel cell byproduct removal system 100 according to the present invention removes more heat from the heat-generating device 160 and/or the fuel cell powered system than would the mere flow of air over a heat sink.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein.

What is claimed is:

1. A fuel cell byproduct removal system, comprising:
a fuel cell;
a water-transporting device coupled to the fuel cell to remove a water byproduct; and
a heat-generating device to facilitate evaporation of the water byproduct.

2. The fuel cell byproduct removal system according to claim 1, wherein the fuel cell byproduct removal system further includes a fan to facilitate evaporation of the water byproduct.

3. The fuel cell byproduct removal system according to claim 1, wherein the water-transporting device delivers the water byproduct to at least one of a water-absorbing material and a water reservoir in close proximity to the heat generating device.

4. The fuel cell byproduct removal system according to claim 3, wherein the water-absorbing material is a sponge.

5. The fuel cell byproduct removal system according to claim 1, wherein the water-transporting device includes a wick.

6. The fuel cell byproduct removal system according to claim 1, wherein the water-transporting device includes a tube.

7. The fuel cell byproduct removal system according to claim 1, wherein the heat-generating device is a semiconductor device.

8. A fuel cell byproduct removal system, comprising:
a fuel cell;
a water-holding device to receive a water byproduct from the fuel cell; and
a heat-generating device in close proximity to the water-holding device to facilitate evaporation of the water byproduct.

9. The fuel cell byproduct removal system according to claim 8, wherein the fuel cell byproduct removal system further includes a fan to facilitate evaporation of the water byproduct.

10. The fuel cell byproduct removal system according to claim 8, wherein the fuel cell includes a water byproduct holding area.

11. The fuel cell byproduct removal system according to claim 8, wherein the water-holding device includes a water-absorbing material to absorb the water byproduct.

12. The fuel cell byproduct removal system according to claim 8, wherein the water-holding device includes a water reservoir.

13. The fuel cell byproduct removal system according to claim 8, wherein the water-holding device includes a water-absorbing material to absorb the water byproduct and a water reservoir.

14. The fuel cell byproduct removal system according to claim 8, wherein the water-holding device includes a sponge.

15. The fuel cell byproduct removal system according to claim 8, wherein the heat-generating device is a semiconductor device.

16. A method of removing water from a fuel cell, comprising:
reacting hydrogen and oxygen in the fuel cell;
converting the hydrogen and the oxygen into electricity;
removing a water byproduct through a water-transporting device;
delivering the water byproduct to a water-holding device; and
evaporating the water byproduct by a heat-generating device in close proximity to the water-holding device.

17. The method according to claim 16, wherein the water-holding device includes a water-absorbing material to absorb the water byproduct.

18. The method according to claim 17, wherein the water-absorbing material is a sponge.

19. The method according to claim 16, wherein the water-holding device includes a water reservoir.

20. The method according to claim 16, wherein the water-holding device includes a water-absorbing material to absorb a water byproduct and a water reservoir.

21. The method according to claim 20, wherein the water-absorbing material is a sponge.

22. The method according to claim 16, wherein the water-transporting device includes a wick.

23. The method according to claim 16, wherein the water-transporting device includes a tube.

24. The method according to claim 16, wherein the heat-generating device is a semiconductor device.

25. A method of removing water from a fuel cell, comprising:
reacting hydrogen and oxygen in the fuel cell;
converting the hydrogen and the oxygen into electricity;
receiving a water byproduct in a water-holding device; and
evaporating the water byproduct by a heat-generating device in close proximity to the water-holding device.

26. The method according to claim 25, wherein the water-holding device includes a water-absorbing material to absorb the water byproduct.

27. The method according to claim 25, wherein the water-holding device includes a water reservoir.

28. The method according to claim 25, wherein the water-holding device includes a water-absorbing material to absorb a water byproduct and a water reservoir.

29. The method according to claim 25, wherein the water-holding device includes a sponge.

30. The method according to claim 25, wherein the heat-generating device is a semiconductor device.

31. A portable electronic device powered by a fuel cell, comprising:
a water-transporting device coupled to the fuel cell to remove a water byproduct; and
a heat-generating device to facilitate evaporation of the water byproduct.

32. The portable electronic device according to claim 31, wherein the portable electronic device further includes a fan to facilitate evaporation of the water byproduct.

33. The portable electronic device according to claim 31, wherein the portable electronic device is a notebook computer.

34. The portable electronic device according to claim 31, wherein the water-transporting device delivers the water byproduct to at least one of a water-absorbing material and a water reservoir in close proximity to the heat generating device.

35. The portable electronic device according to claim 34, wherein the water-absorbing material is a sponge.

36. The portable electronic device according to claim 31, wherein the water-transporting device includes a wick.

37. The portable electronic device according to claim 31, wherein the water-transporting device includes a tube.

38. The portable electronic device according to claim 31, wherein the heat-generating device is a semiconductor device.

39. A portable electronic device powered by a fuel cell, comprising:
a water-holding device to receive a water byproduct from the fuel cell; and
a heat-generating device in close proximity to the water-holding device to facilitate evaporation of the water byproduct.

40. The portable electronic device according to claim 39, wherein the portable electronic device further includes a fan to facilitate evaporation of the water byproduct.

41. The portable electronic device according to claim 39, wherein the portable electronic device is a notebook computer.

42. The portable electronic device according to claim 39, wherein the fuel cell includes a water byproduct holding area.

43. The portable electronic device according to claim 39, wherein the water-holding device includes a water-absorbing material to absorb the water byproduct.

44. The portable electronic device according to claim 39, wherein the water-holding device includes a water reservoir.

45. The portable electronic device according to claim 39, wherein the water-holding device includes a water-absorbing material to absorb the water byproduct and a water reservoir.

46. The portable electronic device according to claim 39, wherein the water-holding device includes a sponge.

47. The portable electronic device according to claim 39, wherein the heat-generating device is a semiconductor device.
